(19) United States
(12) Patent Application Publication
(10) Pub. No.: US 2026/0330337 A1
(43) Pub. Date: Oct. 22, 2026

(54) COMPUTER SOFTWARE SYSTEM AND METHOD FOR PERSONALIZED OUTDOOR TRIP PLANNING, COMMUNICATIONS, DATA PROCESSING AND DISTRIBUTION, AND BEHAVIORAL ANALYTICS

(71) Applicant: Eric Kirtchakov, Blairstown, NJ (US)

(72) Inventor: Eric Kirtchakov, Blairstown, NJ (US)

(21) Appl. No.: 19/463,020

(22) Filed: Jan. 28, 2026

Related U.S. Application Data
(60) Provisional application No. 63/750,288, filed on Jan. 28, 2025.

(51) Int. Cl. G06Q 10/02

(52) U.S. Cl. CPC G06Q 10/025

(57) ABSTRACT

A smart device application that utilizes multimodal sensor data and machine learning to deliver personalized mapping, weather tracking, and activity-specific recommendations. The system forms behavior pattern maps by collecting data from wearable sensors, including GPS, to track user positions and activities. The system calculates a mean behavior pattern map by averaging sensor values associated with various user behaviors. Real-time multimodal sensor data is then processed using a trained machine learning algorithm to predict and label behaviors dynamically. These personalized behavior maps enable the application to offer tailored alerts and recommendations, such as warnings about adverse weather, hazardous terrain, or optimized routes based on the user's activity. For instance, a user on a hiking trail might receive notifications about nearby hazards or terrain difficulty. By integrating real-time data with personalized insights, this application enhances safety and convenience, adapting intelligently to both individual user patterns and environmental conditions.

### CROSS REFERENCE TO RELATED APPLICATION

This patent application is a Utility Non-Provisional Application which claims the benefit and priority of a United Provisional Patent Application No. 63750288, filed on Jan. 28, 2025 the disclosure of which is incorporated by reference herein in its entirety as part of the present application.

### FIELD OF THE EMBODIMENTS

The field of the invention and its embodiments relate to data processing, including database and file management or data structures employed for personalized trip planning. This classification aligns with features such as RSS feed aggregation, behavioral analytics, mapping overlays, and dynamic recommendations generated by a processor.

### BACKGROUND OF THE EMBODIMENTS

Traditional outdoor planning tools are fragmented, requiring users to juggle multiple applications for mapping, weather tracking, and activity-specific recommendations. This fragmentation creates inefficiencies, forcing users to manually integrate data from disparate sources while navigating inconsistent interfaces. Such challenges often result in incomplete or inaccurate information, particularly for users seeking comprehensive and reliable tools for outdoor activities. Further, many existing tools lack the ability to aggregate and process diverse datasets in real-time, leaving users without dynamic updates on factors such as weather changes, terrain conditions, or hazards. These limitations are especially problematic in outdoor environments, where conditions can shift rapidly, requiring up-to-date and accurate information to facilitate safety and effective planning. Many platforms also fail to incorporate features such as collaborative planning, user-specific insights, or advanced analytics that account for individual preferences and historical behaviors. This absence of integration and functionality makes it difficult for users to make informed decisions, increasing the likelihood of incomplete planning or missed opportunities in outdoor trip preparation.

### SUMMARY OF THE EMBODIMENTS

This software solves many challenges by offering a unified platform that consolidates mapping, weather, and activity planning into a single adaptive framework. By integrating real-time data feeds, proprietary analytics, and customizable user interfaces, it provides access to dynamic updates and personalized insights. This approach reduces fragmentation, improves decision-making, and enhances user experiences in outdoor planning. The cloud-based software is configured for real-time data processing in outdoor trip planning platforms. It features RSS feed aggregation, behavioral analytics, mapping overlays, and modular systems for data aggregation and analysis. The engine may process user interactions, historical data, and environmental inputs to generate personalized recommendations, predictive analytics, and premium features. The scalable architecture supports mobile and desktop interfaces, third-party API integration, dynamic updates, and external licensing opportunities.

This software introduces a backend architecture configured for mobile and desktop platforms, optimized for outdoor trip planning and data-driven insights. The system includes a data integration processor for aggregating external feeds including, but not limited to, RSS and APIs to analyze weather, terrain, and/or hazards, generating actionable insights. The dynamic data processing engine enables real-time updates to user-facing features based on environmental changes. An RSS feed system curates aggregated data for internal use, user recommendations, and external licensing. The Behavioral Analytics Engine tracks user interactions, producing anonymized trends to optimize functionality and support external collaborations. The system securely stores user histories, such as trip costs and preferences, in historic data storage, enabling predictive models for future planning. The mapping infrastructure supports dynamic overlays including, but not limited to, trails, hazard markers, and/or annotations, with premium purchasable features including weather radars and/or zoning maps.

Additional functionalities include collaborative planning tools for shared itineraries, group management, and/or participant-specific gear recommendations, as well as emergency response features integrating SOS alerts and real-time safety protocols. AI-driven capabilities enhance terrain analysis and environmental safety suggestions, providing tailored gear recommendations with integrated purchase options and reviews. Influencer-curated gear lists and affiliate sales are supported via content integration tools, enhancing user personalization. The modular architecture supports adaptive scaling for feature expansion, along with a data licensing system for monetizing curated insights and mapping data for outdoor brands. This system combines advanced data processing, user-centric features, and scalable backend technologies to create a highly functional and marketable outdoor trip planning platform.

As noted above, this software has a backend architecture configured to enhance outdoor planning platforms through modular and scalable systems across multiple functionalities. The data integration and processing processor incorporates external data feeds, such as RSS and APIs, into a backend system for analyzing weather, terrain, and hazards. It features a data aggregation engine that converts these inputs into proprietary insights for generating user recommendations, while a dynamic framework facilitates real-time updates to user-facing features based on processed environmental data. The data integration and processing processor aggregates external data feeds, such as RSS and APIs, to provide information on weather, terrain, hazards, and local points of interest. This data is processed using proprietary algorithms to convert raw inputs into actionable insights. The system fetches data from external sources, including government weather services, mapping APIs, and trail databases, through data pipelines. These inputs are then filtered, normalized, and analyzed to generate usable data. The processed insights are securely stored in a database, allowing immediate access by the user interface and analytics engine. For example, when a user plans a hiking trip in a mountainous region, the backend system integrates data on current weather, trail conditions, and hazard warnings, such as avalanche risks. Based on this information, the system dynamically generates safe and appropriate route recommendations to facilitate the user is informed and guided through the most suitable paths, considering real-time environmental conditions.

The behavioral analytics and projections system tracks and analyzes user interactions, providing anonymized insights to identify trends, optimize app functionalities, and support data licensing opportunities. As noted above, the behavioral analytics engine tracks user interactions, including gear selections, route preferences, and trip details, to generate anonymized insights that enhance platform functionality and provide valuable analytics for external partners. The backend system logs user activity and anonymizes the data at the point of collection to facilitate privacy. Machine learning models then analyze these patterns, identifying trends and optimizing future recommendations for users. Additionally, these insights can be exported as anonymized reports to outdoor brands, offering information on gear trends and user behaviors. For example, if the system identifies that users frequently select a particular brand of hiking boots for snowy terrains, it recommends those boots to new users planning trips in similar conditions. This data trend is not only used to improve user experience but can also be licensed to the manufacturer, providing them with valuable market insights to refine their product offerings or marketing strategies.

The Mapping and Customization Tools processor is configured for backend support for dynamic map overlays, including trails, property boundaries, hazards, and purchasable premium layers like weather radars or seasonal updates. Users can annotate, customize, and upload routes, while the system generates proprietary data feeds for licensing to external partners. As noted, the customizable mapping infrastructure provides dynamic mapping capabilities, allowing users to overlay information such as trails, property boundaries, and hazards like flooding or landslides. Users can further personalize maps by annotating them with custom routes, marking points of interest, or uploading GPS trail data. These features facilitate maps not only informative but also tailored to the unique needs and experiences of individual users. The implementation leverages APIs such as Google Maps or OpenStreetMap to integrate reliable base map data. A modular backend framework dynamically renders overlays, ensuring real-time updates to reflect the latest conditions or user inputs. User-generated data, such as annotated trails or points of interest, is securely stored within the system, enabling it to be shared with others or reused for future trips. For instance, a group of hikers might upload a custom trail route and annotate it with water sources, campsites, or hazard warnings. The backend saves these annotations and makes them available to other users planning to explore the same area, fostering a collaborative and resource-rich platform for outdoor enthusiasts.

For safety and emergency features, a backend-supported SOS system integrates hazard overlays and real-time alerts with algorithms that dynamically update safety protocols based on environmental factors. A safety and emergency features processor is configured to enhance user security by providing real-time hazard alerts and emergency response capabilities. Users receive notifications about severe weather, trail closures, or other environmental risks directly on their devices. The system also includes an SOS processor, enabling users to send their location and status to rescue teams during emergencies, ensuring timely assistance. This functionality is powered by continuously monitored hazard data feeds, integrating information from weather services, trail management systems, and other reliable sources. Advanced algorithms assess the risk level of a user's planned itinerary and recommend safer alternatives when necessary. In emergencies, the SOS feature utilizes GPS and mobile networks to communicate the user's exact location and status to emergency responders, prioritizing their safety. For example, if a user is hiking and the system detects an approaching storm, it sends a push notification advising them to seek shelter. Should the situation escalate, the user can activate the SOS function, automatically sharing their location and other details with rescue teams, improving the likelihood of a swift and effective response.

The historic data tracking and analysis feature securely stores trip costs, gear preferences, and user activity history, enabling predictive planning and personalized recommendations. The user interface and personalization tools allow users to input trip destinations, activity preferences, and skill levels, with an AI engine analyzing these inputs alongside weather and terrain data to provide tailored gear recommendations and dynamically updated gear lists. As noted above, a historic data tracking and predictive analytics processor provides a system for storing and analyzing user trip data to enhance future planning and decision-making. It securely logs details such as trip costs, gear usage, routes, and activity history, enabling users to build a comprehensive record of their outdoor experiences. This data is then leveraged by predictive algorithms to offer personalized recommendations and optimizations for similar future trips. To facilitate data privacy, user trip information is encrypted and stored in a secure database. The predictive models analyze patterns in the user's activity, such as frequently used gear, preferred routes, and spending habits. Based on these insights, the system offers tailored advice to improve efficiency, safety, and cost-effectiveness. For instance, the app may alert a user to replace frequently used gear, such as a worn-out sleeping bag or hiking boots, before their next adventure. It can also provide budgeting tips based on expenses from past trips, helping users allocate resources more effectively. As an example, a camper who regularly embarks on weekend getaways is reminded to inspect or replace essential gear, such as a tent or stove, based on historical wear-and-tear data. Additionally, the app might suggest cost-saving measures, like purchasing multipurpose tools or optimizing route choices, to reduce expenses for upcoming trips. By utilizing historical data and predictive analytics, this feature facilitates users to be better prepared and supported in their outdoor pursuits.

For Collaborative Planning and Group Management, features include shared itineraries, live chats with team members, task assignments, expertise designation for group roles, and personalized gear suggestions tailored to individual invitees. As noted above, a collaborative planning backend streamlines group trip organization by providing tools for users to plan excursions collectively. Users may invite friends, share itineraries, and collaborate on trip details within a secure, synchronized environment. In an embodiment, each participant receives personalized gear recommendations and trip responsibilities tailored to their preferences, skill levels, and needs, ensuring a well-organized and efficient planning process. This feature operates through secure servers that host shared itineraries and synchronize updates in real time. The backend analyzes the individual profiles of group members, factoring in their experience levels, equipment preferences, and roles within the trip. Using this data, the system optimizes gear distribution and task allocation to prevent redundancies and facilitate all essentials are covered. For instance, a group planning a weekend camping trip uses the platform to create a shared itinerary. The app analyzes the group's profiles and assigns specific tasks: one participant is recommended to bring a tent, while another is assigned cooking equipment and utensils. This personalized and organized approach minimizes planning confusion, fosters collaboration, and enhances the overall group experience.

The Data Collection and Sharing processor aggregates anonymized user data, such as trip preferences, gear selections, and activity metrics, enhancing AI-driven recommendations and enabling analytics-based influencer-curated gear lists. This processor also supports data-sharing partnerships, allowing outdoor brands to access anonymized insights into gear trends. The Advanced Gear Recommendation Features system provides weather-specific research modes and generates dynamic gear lists with descriptions, user reviews, and purchase options. As noted above a real-time gear recommendations with AI integration processor provides users with dynamically tailored gear lists that align with their trip specifics and real-time environmental conditions. By analyzing details such as destination, activity type, duration, weather, and terrain, the system generates comprehensive recommendations. Each item includes purchase links, detailed descriptions, and user reviews, simplifying the preparation process for outdoor activities. This functionality is powered by an AI engine that processes user profiles, trip parameters, and environmental data. A scoring algorithm evaluates and ranks gear options based on factors like suitability, reliability, and user feedback. For premium users, influencer-curated gear lists are integrated, offering personalized endorsements from experienced outdoor enthusiasts. These lists add a layer of trust and expertise to the recommendations, especially for high-demand or specialized equipment. For example, a backpacker planning a weeklong trek in snowy conditions receives a customized list of essential items, including snowshoes, thermal layers, and a weather-resistant tent. Each item is accompanied by reviews and direct links to purchase options, enabling the user to quickly secure the necessary gear and focus on enjoying their adventure. This dynamic system means that users are always prepared with the right equipment for their specific needs.

The platform leverages AI Capabilities for Terrain and Environmental Analysis to assess terrain difficulty and weather conditions, offering environment-specific safety and equipment suggestions. In an embodiment, the platform's AI-driven terrain and environment analysis evaluates terrain characteristics such as elevation and slope difficulty, alongside environmental factors like temperature and vegetation. By integrating real-time environmental inputs with topographic data, the system calculates terrain difficulty scores, assesses risks, and refines trip suggestions and gear recommendations. For example, a mountain biker planning a steep, rocky trail is recommended rugged tires and protective gear optimized for the conditions.

Monetization is supported through a Licensing and Premium Features Framework, which includes licensing curated analytics to external partners and providing purchasable overlays like weather radars and zoning maps. As noted above, the platform employs diverse strategies to enhance functionality, user engagement, and monetization. Influencer-curated content and data licensing are key revenue drivers. Influencers create gear lists tailored to specific activities or environments, such as “Winter Hiking Essentials,” marketed directly to users within the app. These curated lists generate affiliate sales, compensating influencers and boosting platform revenue. Additionally, the platform licenses anonymized user behavior and analytics data to outdoor brands, providing insights into trends and optimizing product offerings. For example, an influencer's gear list highlighting winter gear can lead to increased sales while benefiting both the influencer and the platform.

In an embodiment, premium features further enhance the user experience by offering live weather radars, seasonal trail updates, and premium zoning maps. These value-added services are integrated into the platform's modular architecture, enabling dynamic scaling to accommodate high user volumes and feature expansions. For instance, a user subscribing to a premium plan can access live weather radar overlays and exclusive hiking trails, improving their trip planning.

Emergency and Safety Response Enhancements facilitate user safety with integrated SOS functionality, real-time hazard alerts, and adaptive protocols for dynamic risk management. As noted above, emergency and hazard management are prioritized through automated safety protocols and real-time alerts. The platform continuously monitors hazard feeds and cross-references them with user locations to provide evacuation plans, nearby shelter locations, and alerts for risks like wildfires or flooding. For example, a camper in the path of a wildfire is promptly notified and guided to the nearest evacuation route.

Offline access and data syncing facilitate reliability in remote areas. Many features such as maps, itineraries, and emergency protocols are accessible without internet connectivity, thanks to data caching systems. When connectivity is restored, a background syncing process updates trip data. For instance, a hiker in a remote area can rely on pre-downloaded maps and safety instructions and have their activity data synced upon returning online.

The platform also fosters community engagement through user-generated content, including reviews, trail updates, and local tips. A voting system highlights the most helpful contributions, while a reputation system rewards active users with perks like premium access or discounts. For example, a user posting a review about a washed-out trail section helps future users avoid hazards and gains recognition within the community.

After registration, users create a secure profile with preferences and skill levels. They input trip details, and the backend processes weather, terrain, and hazard data to generate tailored recommendations. Gear lists with purchase options are provided, and users can invite friends to join trips, with personalized suggestions for each participant. Real-time updates facilitate safety and adaptability, with the app sending hazard alerts and suggesting alternative routes if needed. These interconnected features provide a comprehensive, personalized solution for outdoor planning, prioritizing safety, convenience, and community-driven content.

### BRIEF DESCRIPTION OF THE DRAWINGS

The present disclosure may be better understood, and its numerous features and advantages made apparent to those skilled in the art by referencing the accompanying drawings.

The use of the same reference symbols in different drawings indicates similar or identical items.

FIG. 1 is a flowchart illustrating a method, according to some embodiments of the present disclosure.

FIG. 2 is a flowchart further illustrating the method from FIG. 1, according to some embodiments of the present disclosure.

FIG. 3 is a block diagram illustrating a system, according to some embodiments of the present disclosure.

FIG. 4 is a block diagram further illustrating the system from FIG. 3, according to some embodiments of the present disclosure.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

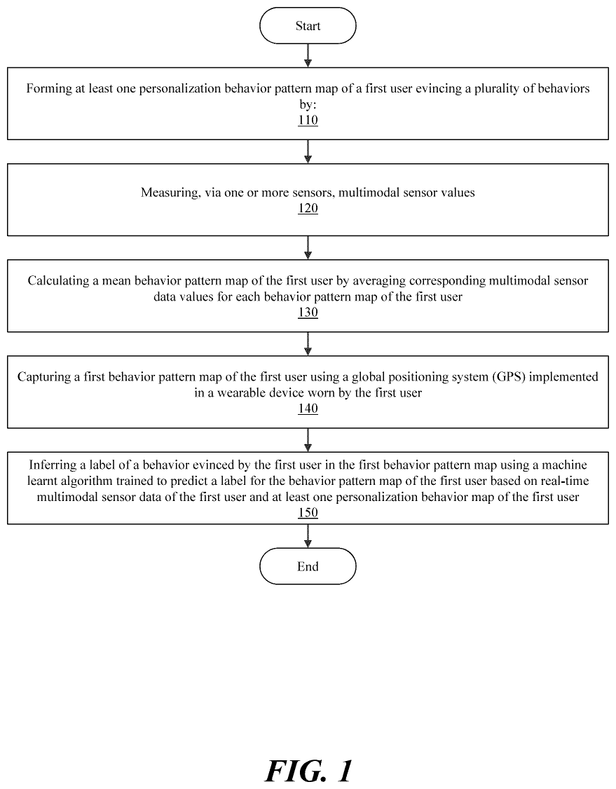

FIGS. 1-4 illustrate example systems and methods of implementing advanced machine learning and AI techniques to predict trip familiarity and enhance user experience through contextualized and adaptive data analysis. In particular, a smart device application is configured for mapping, weather tracking, and providing activity-specific recommendations based on real-time contextual data. The system generates personalized behavior pattern maps for users by leveraging multimodal sensor data from wearable devices, including GPS for positional tracking. Behavior pattern maps are formed by measuring sensor values, such as movement or environmental conditions, and calculating mean behavior patterns through data aggregation. A machine learning algorithm interprets these maps, labeling behaviors based on real-time sensor input and personalized patterns. This enables the application to offer tailored recommendations and alerts for weather changes, terrain conditions, or hazards specific to the user's activity. For example, the system might warn a hiker of a steep incline ahead based on their typical behavior and location. This innovative approach enhances user safety and convenience, adapting dynamically to individual habits and environmental factors.

In one embodiment, a deep learning network, trained on multimodal sensor data such as GPS, accelerometer, and gyroscope inputs, forms the foundation for recognizing user behavior patterns and predicting trip familiarity. To facilitate scalability and adaptability, a transfer learning approach may be employed, enabling the model to quickly adapt to new users by utilizing pre-trained patterns derived from similar datasets. Emotion-driven data analysis further refines the predictions by incorporating wearable device inputs like heart rate and skin temperature to assess emotional responses during trips. This integration allows the system to better understand user preferences for specific routes or activities, tailoring recommendations accordingly.

In an embodiment, the system optimizes efficiency through adaptive sensor sampling, dynamically adjusting sampling rates based on user activity. For instance, GPS sampling frequency decreases when a user is stationary and increases during high-speed activities like biking, ensuring real-time data accuracy while conserving system resources. Temporal data layering organizes sensor data into hierarchical temporal blocks (e.g., daily, weekly), enabling the tracking of long-term trends such as changes in route familiarity over time. This layered structure enhances the system's ability to provide predictive analytics and actionable insights. A user's travel habits are encoded into a unique “behavioral DNA” profile, which captures their preferences, such as favored terrains, typical travel times, and responses to environmental changes. This encoding accelerates the system's capacity to predict trip familiarity and deliver personalized recommendations.

In an embodiment, the software employs AI-Augmented Environmental Mapping by analyzing external data feeds, such as RSS weather alerts and satellite imagery, and cross-referencing them with sensor inputs. This capability identifies environmental shifts, such as trail closures or adverse weather, which may influence trip familiarity, ensuring users receive accurate and context-sensitive updates. These integrated functionalities deliver a comprehensive, intelligent platform for predictive trip management and user-centered enhancements.

In an embodiment the software incorporates advanced functionalities to enhance data processing, user engagement, and energy efficiency. Edge AI Preprocessing facilitates sensor data that is analyzed locally on the user's device using lightweight AI models. For instance, patterns in accelerometer data are identified on-device, and only summarized insights are transmitted to the cloud for further analysis, reducing latency and bandwidth usage. Gamified Familiarity Tracking introduces a dynamic scoring system where each route is assigned a “familiarity score.” This score is visualized through interactive heatmaps or leaderboards. Familiar routes accumulate points, while exploring new routes unlocks achievements, fostering engagement and incentivizing exploration through gamification. For group trips, the system employs Secure Multi-User Data Blending, aggregating data anonymously from all participants. This approach blends familiarity patterns across users to generate optimized shared route recommendations while maintaining data privacy and security, ensuring that no individual data is exposed. To maximize energy efficiency, the software utilizes Predictive Power Saving by forecasting user actions such as stopping or turning. Based on these predictions, the system dynamically manages sensor activity, deactivating unnecessary components to conserve battery life without compromising performance during trips.

FIG. 1 is a flowchart that describes a method, according to some embodiments of the present disclosure. In some embodiments, at block 110, the method may include forming at least one personalization behavior pattern map of a first user evincing a plurality of behaviors. At block 120, the method may include measuring, via one or more sensors, multimodal sensor value. At block 130, the method may include calculating a mean behavior pattern map of the first user by averaging corresponding multimodal sensor data values for each behavior pattern map of the first user.

In some embodiments, at block 140, the method may include capturing a first behavior pattern map of the first user using a global positioning system (GPS) implemented in a wearable device worn by the first user, the GPS may be configured to locate the positioning of the first user. At block 150, the method may include inferring a label of a behavior evinced by the first user in the first behavior pattern map using a machine learnt algorithm trained to predict a label for the behavior pattern map of the first user based on real-time multimodal sensor data of the first user and the at least one personalization behavior map of the first user. Each of the behavior pattern maps of the first user may comprise the first user evincing one or more behaviors. The at least one personalization behavior map may include the mean behavior pattern map.

Based on predictions derived from personalized behavior maps and real-time sensor data, the application can provide a variety of recommendations to enhance the user experience and ensure safety. For example, the system can optimize routes by suggesting safer alternatives when it predicts that the user is nearing steep inclines or hazardous terrain. It can also send timely weather alerts, such as warning of heavy rain expected in 30 minutes, prompting the user to seek shelter or adjust their route. Additionally, the app can offer personalized activity reminders, such as suggesting rest stops or shorter routes if it predicts the user is about to exceed typical energy levels or distance traveled. Hazard warnings can be issued based on the user's history of encountering dangerous conditions, such as wildlife or unstable terrain, allowing the user to stay alert. Health and fatigue monitoring is another key feature, where the app uses heart rate data to suggest slowing down or resting if fatigue levels are predicted to be high. Contextual recommendations are also provided, such as alerts for low-light conditions when the system predicts sunset is near, prompting the user to prepare for night navigation. For group activities, the app can predict popular shared spots or suggest coordination with others based on past group behaviors. Lastly, the system can remind the user to check their equipment, such as warning of low battery levels and suggesting nearby charging stations. These recommendations adapt to real-time conditions, offering helpful and personalized advice that enhances both safety and enjoyment.

The labels associated with the behavior pattern maps play a key role in informing recommendation predictions. These labels are generated using machine learning algorithms trained to recognize specific behaviors based on the user's real-time multimodal sensor data (such as GPS, heart rate, or accelerometer data). Each label corresponds to a distinct behavior pattern, such as “high fatigue,” “approaching hazardous terrain,” or “frequent rest stop.” Once the system labels a behavior, this label is used to trigger specific recommendations. For example, if the system labels a behavior as “high fatigue,” it may predict that the user would benefit from a recommendation to take a rest break or opt for a shorter route. Similarly, if a behavior pattern indicates “approaching steep incline,” the system might suggest a safer route or alert the user to potential hazards ahead. The labeled behavior patterns serve as a foundation for predictive algorithms, which then translate those predictions into actionable, context-aware recommendations that improve user experience, safety, and efficiency.

In some embodiments, the machine learnt algorithm may comprise a deep learning network (DLN)algorithm, the DLN configured to recognize user behavior patterns and predict trip familiarity. In some embodiments, the machine learnt algorithm may be trained using a second behavior pattern map of a plurality of second users evincing one or more behaviors. The one or more behaviors may correspond to values of parameters that indicate at least one of a magnitude and direction of the second user, a presence of the second user within a location, an environmental condition of the location, and a psychological state of the second user at the location, of the plurality of second users evincing the one or more behaviors.

In some embodiments, inferring the label of the behavior evinced by the first user comprises comparing values of the parameters derived from the first behavior pattern map with the values of the parameters that indicate at least one of a magnitude and direction of the second user, a presence of the second user within a location, an environmental condition of the location, and a psychological state of the second user at the location, corresponding to the one or more behaviors.

In some embodiments, inferring the label of the behavior evinced by the first user comprises identifying one of the one or more behaviors that corresponds to a best match between the values of the parameters derived from the first behavior pattern and the values of the parameters that indicate the at least one of a magnitude and direction of the second user, a presence of the second user within a location, an environmental condition of the location, and a psychological state of the second user at the location, corresponding to the identified one of the one or more behaviors.

In some embodiments, the values of the parameters may comprise values of action units that indicate states of physical exertion based heart rate and skin temperature of the plurality of second users. In some embodiments, capturing the first behavior pattern map of the first user comprising using one or more environmental sensors and one or more physiological state sensors implemented in a wearable device worn by the first user. In some embodiments, the one or more sensors may be selected from at least one of an accelerometer, a gyroscope, a magnetometer, an environmental sensor, and a physiological state sensor.

A personalization behavior pattern map is a dynamic, data-driven representation of a user's actions, preferences, and behaviors, created through the continuous collection and analysis of multimodal sensor data from wearable devices. This map is specifically tailored to the individual, capturing key aspects of their physical activity, environmental interactions, and situational contexts. For example, a wearable device like a smartwatch or fitness tracker gathers data from sensors such as GPS, accelerometer, heart rate monitor, and environmental sensors. As the user engages in activities like hiking, running, or cycling, these sensors track patterns of movement, location, and physiological states. The behavior pattern map reflects elements like physical activity patterns, environmental interactions, physiological data, and behavioral trends, such as preferred routes or areas of interest. Over time, the system averages these data points across multiple activities to create a mean behavior pattern map, which provides an overall profile of the user's typical behaviors. This map informs the system's ability to offer personalized recommendations, such as gear suggestions, route guidance, or alerts about potential hazards based on the user's unique patterns.

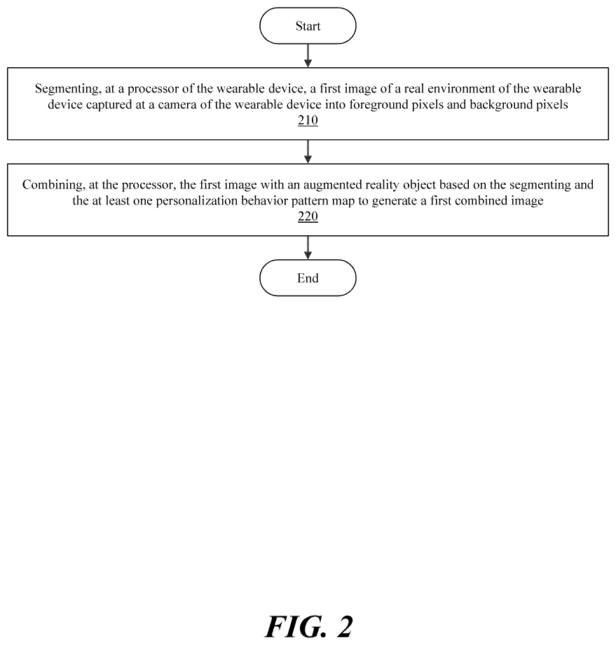

FIG. 2 is a flowchart that further describes the method from FIG. 1, according to some embodiments of the present disclosure. In some embodiments, at block 210, the method may include segmenting, at a processor of the wearable device, a first image of a real environment of the wearable device captured at a camera of the wearable device into foreground pixels and background pixels. At block 220, the method may include combining, at the processor, the first image with an augmented reality object based on the segmenting and the at least one personalization behavior pattern map to generate a first combined image.

As noted above, in some embodiments, at block 210, the method involves segmenting a first image captured by the camera of the wearable device to distinguish between foreground pixels (representing objects in the user's immediate surroundings) and background pixels (representing distant or non-relevant elements). This segmentation process helps in focusing the AR elements on the relevant areas of the user's environment, such as trail markers or obstacles in their path. For instance, if the user is walking along a trail, the processor might identify trees and rocks as foreground elements, while the sky or distant hills would be considered background. At block 220, the segmented image is then combined with an augmented reality (AR) object, such as a trail marker or hazard warning, which is superimposed onto the foreground elements of the image. The combination is informed by the user's personalized behavior pattern map, which could include information such as the user's familiarity with the trail or historical data on the user's preferences and past behaviors. For example, if the user is approaching a familiar area, the system might overlay an AR marker indicating “familiar trail” with a green color, while an unfamiliar or potentially hazardous area could display a warning symbol or red highlight.

The first combined image is then displayed through an AR interface on a phone screen or AR glasses, providing real-time feedback about the user's environment. This interface might show markers indicating the familiarity of the trail, proximity to hazards (e.g., a steep incline or slippery section), and points of interest (POIs), such as rest stops or scenic viewpoints. By integrating personalized behavior data, the system tailors these AR markers based on the user's specific history and preferences, enhancing situational awareness and helping the user make informed decisions.

In an augmented reality (AR) application designed for outdoor activities, such as hiking or trail running, gear recommendations can be overlaid in real-time based on the user's current environment and activity level. For example, as a hiker approaches a challenging section of a trail with steep inclines or rocky terrain, the AR interface detects the difficulty of the terrain through both environmental sensors and the user's behavior pattern map. Based on this, the application could overlay a recommendation on the user's AR display, such as: “Suggested Gear: Traction cleats for better grip on rocky terrain. Tap to add to your gear list.” This recommendation is customized based on the user's activity data and previous behavior patterns, which may indicate that the user tends to struggle with steep or rocky areas. The AR interface could present this suggestion as a floating icon or a text bubble in the user's field of view, with a link to a gear shopping option or a suggestion to check their existing gear. If the user is near a river crossing, the app might suggest water-resistant shoes or a waterproof jacket, again based on the environmental context (e.g., wet terrain) and the user's typical needs in such conditions. This recommendation would help the user better prepare for potential challenges, making their journey safer and more comfortable. These personalized gear recommendations, overlaid into the user's visual environment through the AR interface, assist in making real-time decisions, improving the overall experience, and enhancing safety.

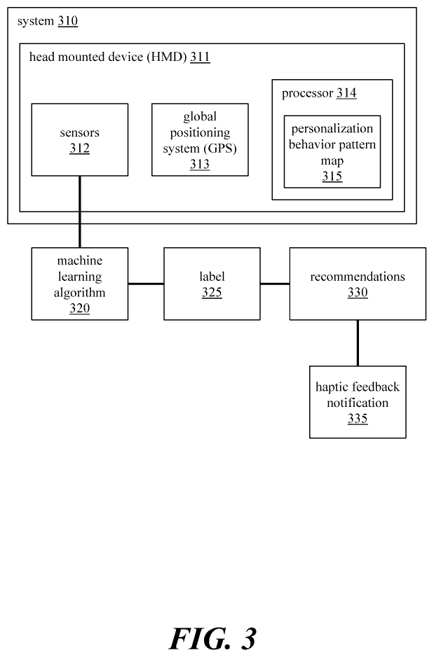

FIG. 3 is a block diagram that describes a system 310, according to some embodiments of the present disclosure. In some embodiments, the system 310 may include a head mounted device (HMD) 311 with one or more sensors 312 configured to measure multimodal sensor values of a first user. The HMD 311 may also include a global positioning system 313 (GPS) configured to capture a first behavior pattern map of a first user. The GPS may be configured to locate the positioning of the first user. The HMD 311 may also include a processor 314 configured to execute computer-readable instructions that, when executed, cause the processor 314 to form at least one personalization behavior pattern map 315 of a first user evincing a plurality of behaviors by calculate a mean behavior pattern map of the first user by averaging corresponding multimodal sensor data values for each behavior pattern map of the first user.

Each behavior pattern map of the first user represents specific behaviors exhibited by the user. A machine learning algorithm 320 is used to infer a label 325 for these behaviors based on real-time multimodal sensor data and the user's personalized behavior pattern map. This algorithm is trained to predict the behavior label by analyzing data patterns, such as the magnitude and direction of the user's movement, their presence in a particular location, environmental conditions, and the user's psychological state. In some embodiments, the algorithm is further trained using behavior pattern maps from a second group of users, which also capture similar data across multiple behaviors.

When executing the machine learning algorithm, the processor compares the parameter values from the first user's behavior map with those of the second users, identifying a match between the parameters that best represents the user's behavior. These parameters may include location, magnitude of movement, environmental conditions, or psychological state at the time of the activity. Based on the inferred label, the system predicts and generates personalized recommendations 330 for the user. For example, if the system identifies a behavior suggesting fatigue or stress, it could recommend a rest stop, a change in route, or a different pace. Conversely, if the system detects that the user is near a favorite trail or a familiar landmark, it might suggest additional activities or points of interest.

Additionally, the system may integrate augmented reality (AR) objects based on the segmented real-world image and the personalization behavior pattern map. This results in a combined image that overlays relevant AR content, which could include markers or indicators related to the user's behavior patterns. The system may also include a haptic feedback 335 feature, providing alerts in response to certain conditions, helping users navigate more effectively while receiving tailored recommendations based on their behavior.

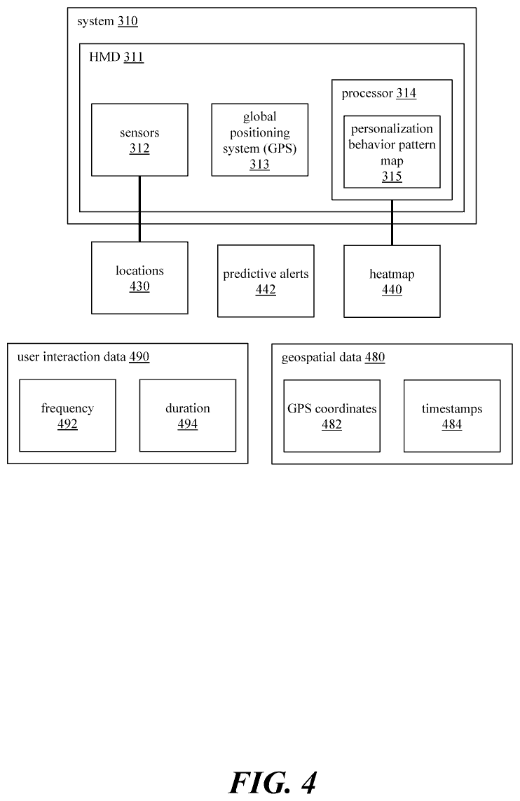

FIG. 4 is a block diagram that provides further details of the system 310 from FIG. 3, according to some embodiments of the present disclosure. In some embodiments, when executed, the computer-readable instructions cause the processor 314 to: (1) collect geospatial data 480 and user interaction data 490 from one or more user devices such as a HMD 311; (2) process the geospatial and interaction data using a computational model to assign familiarity scores to locations within a geographic area. These familiarity scores may be based on various metrics, including but not limited to, the frequency of visits, the amount of time spent at locations, and the recency of visits.

In some embodiments, the system may generate a heatmap visualization of the geographic area by mapping the familiarity scores to a color scale. The heatmap can be dynamically updated in real-time or at predefined intervals based on newly collected geospatial and user interaction data, and it is displayed on a graphical user interface of a user device. The heatmap may be interactive, allowing the user to: (1) zoom in or out to adjust the level of geographic detail, and (2) select specific regions to view associated metadata.

The geospatial data 480 may include GPS coordinates 482 and timestamps 484, while the user interaction data 490 may include metrics such as frequency 492 and duration 494 of user presence at various locations 430. In some embodiments, the computer-readable instructions, when executed, further cause the processor 314 to: (1) integrate a heatmap 440 with predictive alerts 442. This allows the system 310 to identify patterns in the geospatial data 480 and provide context-specific notifications to the user based on those patterns.

The personalization behavior pattern map and the heatmap are closely related components of a system that provides a tailored user experience by analyzing and visualizing geospatial and interaction data. The behavior pattern map tracks and processes the user's interactions with their environment over time, capturing patterns such as frequently visited locations, time spent in specific areas, and other preferences. This data, including metrics like frequency, duration, and recency of visits, directly informs the heatmap. The heatmap visualizes the geographic area and displays familiarity scores for different locations, indicating the user's level of familiarity with those places. The system uses the behavioral data from the pattern map to assign these scores, creating a dynamic and interactive representation of the user's interactions.

Together, the personalization behavior pattern map and heatmap offer complementary insights. The heatmap visualizes areas the user frequently visits or spends time in, with warmer colors representing higher familiarity, while the behavior pattern map predicts how the user might interact with the environment in the future. This relationship allows the system to offer personalized, context-specific notifications and recommendations. For instance, when the user approaches a familiar location, the system could trigger an alert based on the behavior pattern map's predictions, enhancing the overall user experience. Through this integration, the system continuously adapts to the user's evolving preferences, ensuring the presentation of relevant and timely information.

The familiarity score is quantified by analyzing key metrics that reflect the user's interactions with specific locations, including the frequency of visits, time spent at the location, and recency of visits. The frequency of visits tracks how often the user visits a particular location over a set period. Locations visited more frequently are assigned higher familiarity scores, indicating greater familiarity. Time spent at a location also contributes to the score, with longer durations suggesting deeper familiarity. For example, if a user spends several hours at a location like their home or workplace, it would indicate a higher level of familiarity compared to a brief visit. Recency of visits reflects how recently a location was visited, with more recent visits contributing more to the score. Locations visited recently are considered more familiar than those visited a longer time ago. These metrics are typically combined using a weighted average, where each metric is assigned a weight based on its importance. The resulting familiarity score can be visualized on a color scale, with more familiar locations assigned higher scores and highlighted in warmer colors, such as green, while less familiar locations are shown in cooler colors, like red. This dynamic system allows the familiarity score to evolve as new data is collected, providing an up-to-date measure of how familiar the user is with different locations.

The familiarity score is typically calculated using a weighted average of these metrics, with each metric contributing according to its relevance. For example, a simple formula for calculating the familiarity score may include:

Familiarity Score=(w1*Frequency Score)+(w2*Time Spent Score)+(w3*Recency Score)

Where:

w1, w2, w3 are weights assigned to each metric based on its importance.

Frequency Score, Time Spent Score, and Recency Score are normalized values that reflect how often the user visits a location, how much time they spend there, and how recent the visit was.

The resulting familiarity score could be mapped onto a color scale (e.g., green for highly familiar, red for less familiar) and used in visualizations like heatmaps to help the user quickly understand their environment. This score can then be updated dynamically based on new user interactions, allowing the system to adapt in real-time to the user's evolving familiarity with different locations.

Multimodal sensor data refers to the use of data collected from multiple types of sensors, each capturing different aspects or modalities of information. These sensors, often integrated into a single system, provide a more comprehensive and accurate understanding of an environment or user behavior. For example, in wearable devices or mobile apps, multimodal sensor data might include GPS for tracking location and movement, accelerometers for measuring motion, speed, and orientation, and gyroscopes for detecting rotational movements or changes in angular velocity. Other sensors, like heart rate monitors, provide insights into physical activity levels and emotional responses, while temperature sensors measure either the environment's temperature or the user's skin temperature. Barometers can measure atmospheric pressure, which helps determine altitude or detect weather patterns. By combining these various sensor data, the system can offer more nuanced insights, such as recognizing whether a user is walking, running, biking, or driving. Moreover, integrating heart rate and temperature data can reveal the user's physical or emotional state. This integration of diverse sensor inputs is particularly beneficial for applications in health monitoring, navigation, fitness tracking, and enhancing user experiences in apps or wearable technologies.

The system may implement a deep learning network algorithm, such as a Convolutional Neural Network (CNN), to process and analyze complex data patterns. By utilizing multiple layers of interconnected nodes, the algorithm can learn to recognize intricate features within the input data. In the case of CNNs, the network applies convolutional filters to the input, such as images or time-series data, to detect patterns like edges, textures, and more sophisticated structures as the data passes through each layer. This approach is particularly effective for tasks such as image classification, object detection, and video analysis, where spatial relationships within the data are crucial for accurate predictions. The deep learning network's ability to adapt and learn from large datasets makes it an essential tool for the system, enabling advanced predictive analytics and automated decision-making.

Environmental sensors are devices designed to monitor and measure various physical, chemical, and biological parameters of the environment. They play a crucial role in gathering real-time data about external conditions and are widely used in applications such as weather monitoring, pollution control, and smart home systems. There are several types of environmental sensors, each tailored to measure specific factors. Temperature sensors, for example, track the ambient temperature of the environment using thermocouples or thermistors, and are important in weather stations, HVAC systems, and agriculture. Humidity sensors measure the relative humidity in the air, essential for weather forecasting, indoor air quality control, and agricultural monitoring. Pressure sensors detect changes in atmospheric pressure, helping with weather prediction, altitude determination, and leak detection in systems like gas pipelines.

Air quality sensors monitor pollutants in the air, such as carbon dioxide, carbon monoxide, nitrogen dioxide, ozone, particulate matter, and volatile organic compounds, and are vital for environmental monitoring to assess pollution levels and improve air quality. Light sensors measure light intensity and spectrum, and are used in agriculture to monitor plant health, in outdoor lighting systems, and in weather stations. GPS and geospatial sensors track the position, altitude, and movement of objects or people, commonly used in outdoor and mobile applications to monitor changes in location. Gas sensors measure concentrations of specific gases for detecting hazardous substances like methane or for fire risk detection. Rain sensors gauge rainfall presence and intensity, automating irrigation systems or adjusting weather stations to changing conditions.

Soil moisture sensors measure water levels in the soil, commonly used in agriculture to optimize irrigation and water usage. Finally, radiation sensors monitor levels of radiation, such as ultraviolet light or ionizing radiation, and are used for health and safety in environments like nuclear power plants or to detect UV levels in environmental research. These sensors collect real-time data that is transmitted to central systems for analysis, informing decision-making processes and helping to optimize various processes in industries focused on safety, sustainability, and efficiency.

Sensors like heart rate monitors and temperature sensors are often used to assess a user's physiological state, providing valuable insights into stress levels and behavioral responses. These sensors measure bodily functions that are closely linked to emotional and physical stress, allowing systems to infer how a user is reacting to different stimuli, environments, or activities.

Heart rate sensors track the user's pulse, which can fluctuate based on emotional states, physical exertion, or stress. A rapid increase in heart rate can be an indicator of stress, anxiety, or excitement, while a slower, steady heart rate may suggest relaxation or calmness. These sensors typically work through devices such as wearable fitness trackers, smartwatches, or chest straps that use optical or electrical sensors to detect the heart's rhythm and rate.

Temperature sensors, specifically skin temperature sensors, measure the user's skin temperature, which can change due to emotional stress, physical activity, or environmental conditions. Stress, for example, can cause a decrease in peripheral blood flow, resulting in a drop in skin temperature. Conversely, heightened emotional responses like excitement or anger may increase the body's temperature. Wearable devices that measure skin temperature, like smartwatches or patches, can detect these fluctuations in real time, offering another valuable metric to assess stress levels.

Together, heart rate and temperature sensors provide complementary data that can be analyzed to determine emotional and behavioral responses. For instance, a combination of an elevated heart rate and a drop in skin temperature may indicate a stress reaction, while a calm heart rate and stable temperature may suggest the user is relaxed. This type of physiological monitoring can be used in various applications, such as improving user experience in healthcare, monitoring stress in workplace settings, and providing personalized feedback in fitness and wellness applications. Additionally, these sensors can contribute to systems designed to help mitigate stress by suggesting adjustments in environment or behavior based on the real-time physiological data they collect.

The system incorporates a modular API framework designed for dynamic adaptability across diverse hardware configurations. This framework can automatically detect the quality of available GPS signals and switch between satellite-based positioning (GNSS) and Wi-Fi triangulation to optimize performance in varying environments. Central to the system is a proprietary sensor fusion engine that integrates data from multiple sources, including GPS, accelerometers, gyroscopes, barometers, and wearables like smartwatches. This engine enhances the accuracy of determining motion states, such as walking versus running, trip elevation, and environmental conditions.

The software introduces smart hardware coordination through inter-sensor negotiation protocols, allowing connected devices like phones, wearables, and external sensors to collaborate in managing data collection. For instance, a smartwatch might record heart rate data while the phone simultaneously processes GPS information. Adaptive sensor control further optimizes power efficiency by dynamically adjusting sensor activity. The accelerometer, for example, operates in an “event-driven mode,” waking when movement is detected, while GPS sampling decreases during stationary periods and ramps up during high-speed activities.

Wireless device mesh integration leverages a Bluetooth mesh network to synchronize data among nearby devices, such as drones or external GPS units. In a hiking scenario, a drone might relay enhanced GPS signals or camera footage to the system, improving route optimization. AI-driven predictive hardware usage anticipates device needs, such as activating high-precision GPS or adjusting accelerometer sensitivity when approaching unfamiliar terrain. A universal plug-and-play integration layer supports various external devices, including weather monitors, depth sensors, and activity trackers, incorporating their data into the app's analytics.

The system is designed for fault tolerance through a self-healing integration protocol, allowing it to detect and recover from hardware failures. If GPS data is unavailable, the software can fall back on Wi-Fi or accelerometer data to estimate the user's position. Environmental sensor integration adds context-aware functionality, such as incorporating data from air quality monitors or UV detectors to provide recommendations like “Reduce exposure during high UV times on this trail.”

To facilitate contextual adaptability, the system employs interaction modes tailored to specific activities. During urban commutes, it may rely on Wi-Fi signals and accelerometers, while for remote hiking, it activates high-accuracy GPS and barometric pressure readings to monitor terrain details. Secure data exchange is facilitated through blockchain-based verification, which authenticates data from external devices, preventing tampering with inputs like GPS or heart rate data.

Haptic feedback device integration enhances user interaction by incorporating tactile technology to deliver sensory cues, such as vibrations, for navigation guidance and hazard alerts. This hands-free approach enables users to receive real-time information intuitively, without relying on visual or auditory engagement. The system connects with haptic devices like wearable bands, smartwatches, or smartphone vibration motors to emit precise patterns or intensities that communicate specific instructions. For navigation, a single vibration on the left side of a smartwatch might indicate a left turn, while a vibration on the right signals a right turn. Rapid pulses could alert users to stop or recheck their route. In hazard detection, haptic feedback warns of potential dangers, such as obstacles or slippery terrain, by delivering distinct vibration patterns to convey urgency. This integration is particularly beneficial during activities like cycling or hiking, where maintaining situational awareness is crucial. Additionally, users can often customize vibration patterns and intensities to align with their preferences, ensuring the feedback is both noticeable and comfortable.

In an example embodiment, A hiker utilizing the system connects their smartwatch, GPS-enabled drone, and portable UV sensor, creating a dynamic and efficient ecosystem. The software assigns specific roles to each device: the drone tracks the route and provides enhanced GPS data, the smartwatch monitors heart rate and transmits stress indicators to the application, and the UV sensor delivers real-time sun exposure warnings. These integration mechanisms facilitate communication between software and hardware, enhancing the accuracy, functionality, and overall user experience. Additionally, the system supports health monitoring applications native to iOS and Android devices, ensuring compatibility across major platforms.

The user interface incorporates innovative features designed to elevate the user experience. Familiarity heatmaps provide an interactive visual display where frequently traveled areas are highlighted in warm colors like yellow or orange, and unexplored zones appear cool-toned, such as blue or purple, enabling users to distinguish familiar and unfamiliar territories at a glance. Predictive pattern alerts analyze past behavior, offering dynamic suggestions like, “You typically take Route A from this location. Would you like to explore an alternate path today?” These alerts integrate contextual factors, including weather and time constraints, for personalized guidance.

An augmented reality (AR) interface overlays real-time information onto the user's environment, displaying markers for trail familiarity scores, nearby hazards, or points of interest through a phone or AR glasses. Haptic navigation feedback enhances hands-free interaction with subtle vibrations signaling turns or deviations, ensuring users stay oriented without needing to check their devices. A trip narrative dashboard consolidates past journeys into a timeline, incorporating route maps, photos, environmental data, and milestones like the longest hike or steepest climb, providing a personalized history and progress tracker.

For real-time decision-making, a dashboard displays trip metrics such as familiarity scores, hazard probabilities, estimated time of arrival, battery conservation status, and weather updates, allowing users to tap on any metric for detailed insights or recommendations. A gamified exploration interface encourages users to discover new routes by unlocking “hidden zones” and earning badges for milestones like exploring unfamiliar trails. Collaborative trip planning enables group interaction, displaying participant gear lists, expertise levels, familiarity scores, and annotated routes in a unified view.

The adaptive UI adjusts dynamically to environmental conditions: a high-contrast theme activates in bright sunlight, while a dimmed, eye-friendly dark mode is employed at night. Customizable widgets allow users to pin key metrics, such as familiarity scores or hazard levels, directly to their home screen for instant access.

The system offers a range of features designed to enhance user interaction, functionality, and efficiency, particularly for outdoor enthusiasts. Proximity-based notifications provide timely alerts as users approach landmarks or potential hazards. For instance, a user hiking through unfamiliar terrain might receive a warning such as, “Caution: Unfamiliar steep incline ahead,” or a reminder like, “You're near a favorite rest spot from a previous trip.” Emotion-driven adjustments are another standout feature. By syncing with wearable devices that monitor stress or fatigue, the interface dynamically adapts to the user's needs. For example, if stress levels spike, the system might suggest nearby rest points, propose shorter routes, or display calming visuals or motivational messages based on user preferences.

The system's voice-activated interface facilitates hands-free interaction, allowing users to stay focused on their activities. With simple commands like, “What's my current familiarity score?” or “Show alternative routes for avoiding this hazard,” users can easily access information without disrupting their experience. To further guide users, the route familiarity score visualization provides real-time feedback through tools like progress bars or radial charts. For example, as a user revisits familiar trails, their familiarity score dynamically increases, offering a clear indication of progress. Additionally, the offline mode enhances reliability in remote areas by providing pre-downloaded maps, emergency protocols, and cached familiarity data, ensuring uninterrupted access even without network connectivity.

An example use case illustrates these features in action. A hiker exploring a new forest trail begins their journey with the system displaying a heatmap, where unexplored areas appear in cool colors like blue and purple. As they progress, an augmented reality (AR) overlay on their phone highlights nearby landmarks and potential hazards, such as a narrow bridge ahead. Subtle haptic alerts nudge them when they stray from the trail, and as evening approaches, the interface automatically switches to an eye-friendly dark mode. At the end of the hike, the user earns a gamified badge for discovering a “hidden zone,” rewarding their exploration and adding a playful, motivational element.

The software also excels in efficiency through innovative power management. Context-aware sensor management dynamically activates sensors like GPS and accelerometers only when necessary. For instance, GPS operates at full power during active navigation but transitions to low-power Wi-Fi triangulation in urban environments. Predictive power allocation further conserves energy by using machine learning to anticipate user behavior; if a user nears the end of a trip, the system reduces sensor polling rates to save battery. Low-power data compression techniques, such as wavelet compression for accelerometer data and run-length encoding for repetitive GPS patterns, reduce transmission size while maintaining accuracy. Additionally, energy-efficient data aggregation combines multiple sensor readings into single transmission packets, minimizing network usage. For group trips, the system leverages multi-device power sharing, creating a Bluetooth mesh network where the device with the highest remaining battery handles intensive tasks like data processing.

The system incorporates advanced techniques for optimizing data transmission and battery efficiency, facilitate functionality even in resource-constrained scenarios. Opportunistic data syncing schedules large data transmissions, such as trip logs, during periods of low activity or when a Wi-Fi connection is available. For instance, the app might pause data uploads with a notification like, “Data upload paused until Wi-Fi is available or battery level exceeds 50%.” Edge AI enables local preprocessing of sensor data, using lightweight models to generate summary insights. Information, such as hazard alerts or trip anomalies, is transmitted to the cloud, reducing bandwidth usage while maintaining relevance.

Adaptive sampling rates dynamically adjust sensor activity based on environmental conditions. For example, on smooth terrain, accelerometers operate at lower frequencies to conserve power, while in rugged areas, higher sampling rates facilitate accurate tracking. The system also employs incremental data transmission, sending urgent data like real-time hazard alerts immediately while delaying non-essential data such as trip statistics for future syncs.

Battery optimization is enhanced through innovative features such as solar augmentation awareness. When connected to external power sources like solar chargers, the app activates high-power mode, enabling comprehensive data logging with all sensors and features. Sleep cycle integration further conserves energy by detecting when users are stationary, such as during rest periods, and switching to a low-power monitoring mode. Device-specific optimization profiles tailor app behavior to the device's battery health and capacity. For example, on older devices, lightweight features are prioritized, and real-time analytics are minimized to extend usability.

The system's efficiency extends to cutting-edge techniques, including quantum data routing for future networks, ensuring instantaneous and secure data transmission without excessive energy consumption. Intelligent data reduction uses AI to filter redundant or irrelevant sensor data, such as duplicate GPS readings, before transmission. This is complemented by incremental packet transmission, which divides data into smaller chunks sent progressively over intermittent connections, minimizing the risk of upload interruptions.

For sustainability-conscious users, the app features an eco-mode that disables non-critical sensors and simplifies the UI to reduce processing load. In a practical use case, a hiker embarking on a trip with eco-mode enabled benefits from dynamic GPS sampling to conserve battery, while edge AI processes accelerometer data locally, flagging movements like abrupt stops for upload. At rest points, the app aggregates data packets and schedules uploads only when a Wi-Fi connection is detected. Additionally, the system forms a mesh network with nearby devices to offload processing tasks, further conserving the hiker's phone battery.

In some aspects, the techniques described herein relate to a method, including: forming at least one personalization behavior pattern map of a first user evincing a plurality of behaviors by: measuring, via one or more sensors, multimodal sensor values; calculating a mean behavior pattern map of the first user by averaging corresponding multimodal sensor data values for each behavior pattern map of the first user, wherein each of the behavior pattern maps of the first user include the first user evincing one or more behaviors, and wherein the at least one personalization behavior map includes the mean behavior pattern map; capturing a first behavior pattern map of the first user using a global positioning system (GPS) implemented in a wearable device worn by the first user, the GPS is configured to locate the positioning of the first user; and inferring a label of a behavior evinced by the first user in the first behavior pattern map using a machine learnt algorithm trained to predict a label for the behavior pattern map of the first user based on real-time multimodal sensor data of the first user and the at least one personalization behavior map of the first user.

In some aspects, the techniques described herein relate to a method, wherein the machine learnt algorithm includes a deep learning network (DLN) algorithm, the DLN configured to recognize user behavior patterns and predict trip familiarity.

In some aspects, the techniques described herein relate to a method, wherein the machine learnt algorithm is trained using a second behavior pattern map of a plurality of second users evincing one or more behaviors, wherein the one or more behaviors correspond to values of parameters that indicate at least one of a magnitude and direction of the second user, a presence of the second user within a location, an environmental condition of the location, and a psychological state of the second user at the location, of the plurality of second users evincing the one or more behaviors.

In some aspects, the techniques described herein relate to a method, wherein inferring the label of the behavior evinced by the first user includes comparing values of the parameters derived from the first behavior pattern map with the values of the parameters that indicate at least one of a magnitude and direction of the second user, a presence of the second user within a location, an environmental condition of the location, and a psychological state of the second user at the location, corresponding to the one or more behaviors.

In some aspects, the techniques described herein relate to a method, wherein inferring the label of the behavior evinced by the first user includes identifying one of the one or more behaviors that corresponds to a best match between the values of the parameters derived from the first behavior pattern and the values of the parameters that indicate the at least one of a magnitude and direction of the second user, a presence of the second user within a location, an environmental condition of the location, and a psychological state of the second user at the location, corresponding to the identified one of the one or more behaviors.

In some aspects, the techniques described herein relate to a method, wherein the values of the parameters include values of action units that indicate states of physical exertion based heart rate and skin temperature of the plurality of second users.

In some aspects, the techniques described herein relate to a method, wherein capturing the first behavior pattern map of the first user including using one or more environmental sensors and one or more physiological state sensors implemented in a wearable device worn by the first user.

In some aspects, the techniques described herein relate to a method, wherein the one or more sensors are selected from at least one of an accelerometer, a gyroscope, a magnetometer, an environmental sensor, and a physiological state sensor.

In some aspects, the techniques described herein relate to a method, further including:

segmenting, at a processor of the wearable device, a first image of a real environment of the wearable device captured at a camera of the wearable device into foreground pixels and background pixels; and combining, at the processor, the first image with an augmented reality object based on the segmenting and the at least one personalization behavior pattern map to generate a first combined image.

In some aspects, the techniques described herein relate to a system including: a head mounted device (HMD) including: one or more sensors configured to measure multimodal sensor values of a first user; a global positioning system (GPS) configured to capture a first behavior pattern map of a first user, the GPS is configured to locate the positioning of the first user; and a processor configured to execute computer-readable instructions that, when executed, cause the processor to: form at least one personalization behavior pattern map of a first user evincing a plurality of behaviors by: calculate a mean behavior pattern map of the first user by averaging corresponding multimodal sensor data values for each behavior pattern map of the first user, wherein each of the behavior pattern maps of the first user include the first user evincing one or more behaviors, and wherein the at least one personalization behavior map includes the mean behavior pattern map; and infer a label of a behavior evinced by the first user in the first behavior pattern map using a machine learnt algorithm trained to predict a label for the behavior pattern map of the first user based on real-time multimodal sensor data of the first user and the at least one personalization behavior map of the first user.

In some aspects, the techniques described herein relate to a system, wherein the machine learnt algorithm includes a deep learning network (DLN) algorithm, the DLN configured to recognize user behavior patterns and predict trip familiarity.

In some aspects, the techniques described herein relate to a system, wherein the machine learnt algorithm is trained using a second behavior pattern map of a plurality of second users evincing one or more behaviors, wherein the one or more behaviors correspond to values of parameters that indicate at least one of a magnitude and direction of the second user, a presence of the second user within a location, an environmental condition of the location, and a psychological state of the second user at the location, of the plurality of second users evincing the one or more behaviors.

In some aspects, the techniques described herein relate to a system, wherein the computer-readable instructions, when executed, further cause the processor to: infer the label of the behavior evinced by the first user includes comparing values of the parameters derived from the first behavior pattern map with the values of the parameters that indicate at least one of a magnitude and direction of the second user, a presence of the second user within a location, an environmental condition of the location, and a psychological state of the second user at the location, corresponding to the one or more behaviors.

In some aspects, the techniques described herein relate to a system, wherein the computer-readable instructions, when executed, further cause the processor to: infer the label of the behavior evinced by the first user includes identifying one of the one or more behaviors that corresponds to a best match between the values of the parameters derived from the first behavior pattern and the values of the parameters that indicate the at least one of a magnitude and direction of the second user, a presence of the second user within a location, an environmental condition of the location, and a psychological state of the second user at the location, corresponding to the identified one of the one or more behaviors.

In some aspects, the techniques described herein relate to a system, wherein the values of the parameters include values of action units that indicate states of physical exertion based heart rate and skin temperature of the plurality of second users.

In some aspects, the techniques described herein relate to a system, wherein the one or more sensors are selected from at least one of an accelerometer, a gyroscope, a magnetometer, an environmental sensor, and a physiological state sensor.

In some aspects, the techniques described herein relate to a system, wherein the computer-readable instructions, when executed, further cause the processor to: segment, at a processor of the HMD, a first image of a real environment of the HMD captured at a camera of the HMD into foreground pixels and background pixels; and combine, at the processor, the first image with an augmented reality object based on the segmenting and the at least one personalization behavior pattern map to generate a first combined image.

In some aspects, the techniques described herein relate to a system, further including: a haptic navigation feedback alert system configured to generate a signal responsive to one or more predetermined conditions.

In some aspects, the techniques described herein relate to a system, wherein the computer-readable instructions, when executed, further cause the processor to: collect geospatial data and user interaction data from one or more user devices, wherein the geospatial data includes GPS coordinates and timestamps, and the user interaction data includes frequency and duration of user presence at specific locations; process the geospatial and interaction data using a computational model to assign familiarity scores to locations within a geographic area, wherein the familiarity score is based on metrics including, but not limited to, frequency of visits, time spent, and recency of visits; generate a heatmap visualization of the geographic area by mapping the familiarity scores to a color scale, wherein: locations with higher familiarity scores are represented by warm colors, and locations with lower familiarity scores are represented by cool colors; dynamically update the heatmap in real-time or at predefined intervals based on newly collected geospatial and user interaction data; and display the heatmap on a graphical user interface of a user device, wherein the heatmap is interactive and allows the user to: zoom in or out to adjust a level of geographic detail, filter heatmap data based on time periods or activity types, and select specific regions to view associated metadata, including visit frequency and duration.

In some aspects, the techniques described herein relate to a system, wherein the computer-readable instructions, when executed, further cause the processor to: integrate the heatmap with predictive alerts, wherein the system identifies patterns in the geospatial data and provides context-specific notifications to the user, including recommendations for exploring unfamiliar areas or warnings about high-traffic regions.

In some embodiments, certain aspects of the techniques described above may be implemented by one or more processors of a processing system executing software. The software comprises one or more sets of executable instructions stored or otherwise tangibly embodied on a non-transitory computer readable storage medium. The software may include the instructions and certain data that, when executed by the one or more processors, manipulate the one or more processors to perform one or more aspects of the techniques described above. The non-transitory computer readable storage medium may include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media may include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes may be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method, comprising:
forming at least one personalization behavior pattern map of a first user evincing a plurality of behaviors by:
measuring, via one or more sensors, multimodal sensor values;
calculating a mean behavior pattern map of the first user by averaging corresponding multimodal sensor data values for each behavior pattern map of the first user, wherein each of the behavior pattern maps of the first user comprise the first user evincing one or more behaviors, and wherein the at least one personalization behavior map includes the mean behavior pattern map;
capturing a first behavior pattern map of the first user using a global positioning system (GPS) implemented in a wearable device worn by the first user, the GPS is configured to locate the positioning of the first user; and
inferring a label of a behavior evinced by the first user in the first behavior pattern map using a machine learnt algorithm trained to predict a label for the behavior pattern map of the first user based on real-time multimodal sensor data of the first user and the at least one personalization behavior map of the first user.

2. The method of claim 1, wherein the machine learnt algorithm comprises a deep learning network (DLN) algorithm, the DLN configured to recognize user behavior patterns and predict trip familiarity.

3. The method of claim 1, wherein the machine learnt algorithm is trained using a second behavior pattern map of a plurality of second users evincing one or more behaviors, wherein the one or more behaviors correspond to values of parameters that indicate at least one of a magnitude and direction of the second user, a presence of the second user within a location, an environmental condition of the location, and a psychological state of the second user at the location, of the plurality of second users evincing the one or more behaviors.

4. The method of claim 3, wherein inferring the label of the behavior evinced by the first user comprises comparing values of the parameters derived from the first behavior pattern map with the values of the parameters that indicate at least one of a magnitude and direction of the second user, a presence of the second user within a location, an environmental condition of the location, and a psychological state of the second user at the location, corresponding to the one or more behaviors.

5. The method of claim 4, wherein inferring the label of the behavior evinced by the first user comprises identifying one of the one or more behaviors that corresponds to a best match between the values of the parameters derived from the first behavior pattern and the values of the parameters that indicate the at least one of a magnitude and direction of the second user, a presence of the second user within a location, an environmental condition of the location, and a psychological state of the second user at the location, corresponding to the identified one of the one or more behaviors.

6. The method of claim 5, wherein the values of the parameters comprise values of action units that indicate states of physical exertion based heart rate and skin temperature of the plurality of second users.

7. The method of claim 1, wherein capturing the first behavior pattern map of the first user comprising using one or more environmental sensors and one or more physiological state sensors implemented in a wearable device worn by the first user.

8. The method of claim 1, wherein the one or more sensors are selected from at least one of an accelerometer, a gyroscope, a magnetometer, an environmental sensor, and a physiological state sensor.

9. The method of claim 1, further comprising:
segmenting, at a processor of the wearable device, a first image of a real environment of the wearable device captured at a camera of the wearable device into foreground pixels and background pixels; and
combining, at the processor, the first image with an augmented reality object based on the segmenting and the at least one personalization behavior pattern map to generate a first combined image.

10. A system comprising:
a head mounted device (HMD) comprising:
one or more sensors configured to measure multimodal sensor values of a first user;
a global positioning system (GPS) configured to capture a first behavior pattern map of a first user, the GPS is configured to locate the positioning of the first user; and
a processor configured to execute computer-readable instructions that, when executed, cause the processor to:
form at least one personalization behavior pattern map of a first user evincing a plurality of behaviors by:
calculate a mean behavior pattern map of the first user by averaging corresponding multimodal sensor data values for each behavior pattern map of the first user, wherein each of the behavior pattern maps of the first user comprise the first user evincing one or more behaviors, and wherein the at least one personalization behavior map includes the mean behavior pattern map; and
infer a label of a behavior evinced by the first user in the first behavior pattern map using a machine learnt algorithm trained to predict a label for the behavior pattern map of the first user based on real-time multimodal sensor data of the first user and the at least one personalization behavior map of the first user.

11. The system of claim 10, wherein the machine learnt algorithm comprises a deep learning network (DLN) algorithm, the DLN configured to recognize user behavior patterns and predict trip familiarity.

12. The system of claim 10, wherein the machine learnt algorithm is trained using a second behavior pattern map of a plurality of second users evincing one or more behaviors, wherein the one or more behaviors correspond to values of parameters that indicate at least one of a magnitude and direction of the second user, a presence of the second user within a location, an environmental condition of the location, and a psychological state of the second user at the location, of the plurality of second users evincing the one or more behaviors.

13. The system of claim 12, wherein the computer-readable instructions, when executed, further cause the processor to:
infer the label of the behavior evinced by the first user comprises comparing values of the parameters derived from the first behavior pattern map with the values of the parameters that indicate at least one of a magnitude and direction of the second user, a presence of the second user within a location, an environmental condition of the location, and a psychological state of the second user at the location, corresponding to the one or more behaviors.

14. The system of claim 13, wherein the computer-readable instructions, when executed, further cause the processor to:
infer the label of the behavior evinced by the first user comprises identifying one of the one or more behaviors that corresponds to a best match between the values of the parameters derived from the first behavior pattern and the values of the parameters that indicate the at least one of a magnitude and direction of the second user, a presence of the second user within a location, an environmental condition of the location, and a psychological state of the second user at the location, corresponding to the identified one of the one or more behaviors.

15. The system of claim 14, wherein the values of the parameters comprise values of action units that indicate states of physical exertion based heart rate and skin temperature of the plurality of second users.

16. The system of claim 10, wherein the one or more sensors are selected from at least one of an accelerometer, a gyroscope, a magnetometer, an environmental sensor, and a physiological state sensor.

17. The system of claim 10, wherein the computer-readable instructions, when executed, further cause the processor to:
segment, at a processor of the HMD, a first image of a real environment of the HMD captured at a camera of the HMD into foreground pixels and background pixels; and
combine, at the processor, the first image with an augmented reality object based on the segmenting and the at least one personalization behavior pattern map to generate a first combined image.

18. The system of claim 10, further comprising:
a haptic navigation feedback alert system configured to generate a signal responsive to one or more predetermined conditions.

19. The system of claim 10, wherein the computer-readable instructions, when executed, further cause the processor to:
collect geospatial data and user interaction data from one or more user devices, wherein the geospatial data includes GPS coordinates and timestamps, and the user interaction data includes frequency and duration of user presence at specific locations;
process the geospatial and interaction data using a computational model to assign familiarity scores to locations within a geographic area, wherein the familiarity score is based on metrics including, but not limited to, frequency of visits, time spent, and recency of visits;
generate a heatmap visualization of the geographic area by mapping the familiarity scores to a color scale, wherein:
locations with higher familiarity scores are represented by warm colors, and
locations with lower familiarity scores are represented by cool colors;
dynamically update the heatmap in real-time or at predefined intervals based on newly collected geospatial and user interaction data; and
display the heatmap on a graphical user interface of a user device, wherein the heatmap is interactive and allows the user to:
zoom in or out to adjust a level of geographic detail,
filter heatmap data based on time periods or activity types, and
select specific regions to view associated metadata, including visit frequency and duration.

20. The system of claim 19, wherein the computer-readable instructions, when executed, further cause the processor to:
integrate the heatmap with predictive alerts, wherein the system identifies patterns in the geospatial data and provides context-specific notifications to the user, including recommendations for exploring unfamiliar areas or warnings about high-traffic regions.
